(19) United States
(12) Patent Application Publication
(10) Pub. No.: US 2023/0237406 A1
(43) Pub. Date: Jul. 27, 2023

(54) ANALYSIS DEVICE AND ANALYSIS METHOD

(71) Applicant: Hitachi, Ltd., Tokyo (JP)

(72) Inventors: Hiromitsu NAKAGAWA, Tokyo (JP); Shigenori MATSUMOTO, Tokyo (JP)

(73) Assignee: Hitachi, Ltd., Tokyo (JP)

(21) Appl. No.: 17/943,939

(22) Filed: Sep. 13, 2022

(30) Foreign Application Priority Data
Jan. 27, 2022 (JP) 2022-011229

(51) Int. Cl. G06Q 10/06; H04W 4/02; H04W 4/021

(52) U.S. Cl. CPC G06Q 10/0635; H04W 4/023; H04W 4/021

(57) ABSTRACT

Provided is an analysis device including a processor and a storage device. The storage device holds behavior history information indicating a period in which each of a first terminal device and a second terminal device has stayed in a predetermined area of a space and a predetermined remaining period. The processor identifies, as a period of a direct contact, a period in which the first terminal device and the second terminal device have simultaneously stayed in the predetermined area, and, identifies, as a period of an indirect contact, a period which is included in a period from an end point of the period in which the first terminal device has stayed in the predetermined area until the predetermined remaining period elapses, and in which the second terminal device has stayed in the predetermined area.

### CLAIM OF PRIORITY

The present application claims priority from Japanese patent application JP2022-011229 filed on Jan. 27, 2022, the content of which is hereby incorporated by reference into this application.

### BACKGROUND OF THE INVENTION

This invention relates to analysis processing for measurement data.

In recent years, as the infection of the COVID-19 (novel coronavirus infection) spreads, ways of working of office workers have diversified in order to simultaneously achieve prevention of infection and continuation of business. For example, it is possible to name such ways of working as selecting a time period for work to avoid congestion and selecting a place for work to avoid crowding.

It is thus important for a company to appropriately manage the ways of working having a high degree of freedom in time and place, and to quickly and accurately grasp states such as presence or absence of a contact between employees when a risk relating to the continuation of business, such as infection, occurs. For the management and grasping, a positioning technology is one of effective measures.

According to JP 2021-170760 A, there is disclosed a configuration in which a time, an intensity, and an identifier are recorded in a transmitter and a receiver, to thereby extract a contact between transmitters. As a result, it is possible to determine whether or not a contact between employees has occurred.

According to JP 6846727 B1, there is disclosed a configuration in which IoT devices are installed in various places in addition to terminals to identify a place of a positive person, to thereby transmit a notification of warning. As a result, it is possible to determine whether or not a contact between employees has occurred.

### SUMMARY OF THE INVENTION

With the technology as disclosed in JP 2021-170760 A, it is possible to determine the contact between the employees, but there is a problem in that an indirect contact via a place cannot be determined.

With the technology as disclosed in JP 6846727 B1, it is possible to determine the contact between the employees, but there is a problem in that the cost is high and a risk is not clear.

It is therefore an object of this invention to quantitatively evaluate a risk of an indirect contact between employees in addition to a direct contact between employees without an excessive cost to install devices.

In order to solve at least one of the foregoing problems, one embodiment of this invention is an analysis device, comprising: a processor; and a storage device, wherein the storage device is configured to hold behavior history information indicating a period in which each of a first terminal device and a second terminal device has stayed in a predetermined area of a space and a predetermined remaining period, and wherein the processor is configured to: identify, as a period of a direct contact, a period in which the first terminal device and the second terminal device have simultaneously stayed in the predetermined area; and identify, as a period of an indirect contact, a period which is included in a period from an end point of the period in which the first terminal device has stayed in the predetermined area until the predetermined remaining period elapses, and in which the second terminal device has stayed in the predetermined area.

According to the at least one aspect of this invention, it is possible to determine the indirect contact in addition to the direct contact by extracting terminal IDs which have used the same area at the same time and in a virus remaining period. Problems, configurations, and effects other than those described above are clarified by the following description of embodiments of this invention.

### BRIEF DESCRIPTION OF THE DRAWINGS

FIG. 1 is an explanatory diagram for illustrating an overall configuration of a contact determination system which achieves a solution in a first embodiment of this invention.

FIG. 2 is a block diagram for illustrating a hardware configuration of the contact determination system in the first embodiment.

FIG. 3 is a block diagram for illustrating a logical configuration of the entire contact determination system in the first embodiment.

FIG. 4 is an explanatory diagram for illustrating configurations of tables stored in a measurement DB in the first embodiment.

FIG. 5 is an explanatory diagram for illustrating configurations of tables stored in a definition DB in the first embodiment.

FIG. 6 is an explanatory diagram for illustrating configurations of tables stored in a record DB in the first embodiment.

FIG. 7 is an explanatory diagram for illustrating configurations of tables stored in a determination DB in the first embodiment.

FIG. 8 is a flowchart for illustrating processing executed by a radio wave information transmission module of a transmission device in the first embodiment.

FIG. 9 is a flowchart for illustrating processing executed by a radio wave information recording module of a measurement device in the first embodiment.

FIG. 10 is a flowchart for illustrating processing executed by a read information recording module of the measurement device in the first embodiment.

FIG. 11 is a flowchart for illustrating processing executed by a measurement information transmission module of the measurement device in the first embodiment.

FIG. 12 is a flowchart for illustrating processing executed by a behavior information recording module of an analysis device in the first embodiment.

FIG. 13 is a flowchart for illustrating processing executed by a behavior extraction module of the analysis device in the first embodiment.

FIG. 14 is a flowchart for illustrating processing executed by a contact information generation module of the analysis device in the first embodiment.

FIG. 15 is a flowchart for illustrating processing executed by a determination likelihood calculation module of the analysis device in the first embodiment.

FIG. 16 is a block diagram for illustrating the logical configuration of an entire contact determination system in a second embodiment.

FIG. 17 is a flowchart for illustrating processing executed by a behavior extraction execution module of an analysis device in the second embodiment.

FIG. 18 is a flowchart for illustrating processing executed by an area generation module of the analysis device in the second embodiment.

FIG. 19 is a flowchart for illustrating processing executed by a search condition setting module of the analysis device in the second embodiment.

FIG. 20 is a flowchart for illustrating processing executed by a U/I control module of the analysis device in the second embodiment.

FIG. 21 is an explanatory diagram for illustrating a contact determination screen displayed by the analysis device in the second embodiment.

### DETAILED DESCRIPTION OF THE PREFERRED EMBODIMENTS

Some embodiments of this invention are described below with reference to the drawings. However, it should be noted that those embodiments are merely examples for achieving this invention and do not limit a technical scope of this invention.

In the following description, “interface unit” is one or more interface devices. The one or more interfaces may be one or more interface devices of the same type (for example, one or more network interface cards (NICs)) or two or more interface devices of different types (for example, an NIC and a host bus adapter (HBA)).

Moreover, in the following description, “storage unit” is one or more memories. At least one memory may be a volatile memory or a nonvolatile memory. The storage unit may include one or more PDEVs as well as the one or more memories. “PDEV” means a physical storage device, and may typically be a nonvolatile storage device (for example, auxiliary storage device). The PDEV may be, for example, a hard disk drive (HDD) or a solid state drive (SSD).

Moreover, in the following description, “processor unit” is one or more processors. At least one processor is typically a central processing unit (CPU). The processor may include a hardware circuit which partially or entirely execute processing.

Moreover, in the following description, a function is sometimes described by using an expression of “kkk module” (excluding the interface unit, the storage unit, and the processor unit). This function may be implemented by the processor unit executing one or more computer programs, or may be implemented by a one or more hardware circuits (for example, (field-programmable gate array (FPGA) or an application specific integrated circuit (ASIC)). When the function is implemented by the processor unit executing a program, defined processing is executed while the storage unit, the interface unit, and/or the like are/is appropriately used, and hence the function may be considered as at least a part of the processor unit. Processing described with use of the function as the subject of a sentence may be processing executed by the processor unit or a device including the processor unit. The program may be installed from a program source. The program source may be, for example, a program distribution computer or a computer-readable recording medium (for example, non-transitory recording medium). Description of each function is an example. A plurality of functions may be unified into one function, or one function may be divided into a plurality of functions.

Moreover, in the following description, information is sometimes described by using an expression of “xxx table.” However, the information may be expressed in any data structure. That is, in order to indicate that the information does not depend on the data structure, “xxx table” may be described as “xxx information.” Moreover, in the following description, a configuration of each table is an example. One table may be divided into two or more tables, or all or a part of two or more tables may be one table.

Moreover, in the following description, “time” is expressed in units of the year, the month, the day, the hour, the minute, and the second. However, the unit of the time may be coarser or finer, or different units may be used.

Moreover, in the following description, “dataset” means data (block of logical electronic data) formed of one or more data elements, and may be any one of, for example, a record, a file, a key-value pair, and a tuple.

### First Embodiment

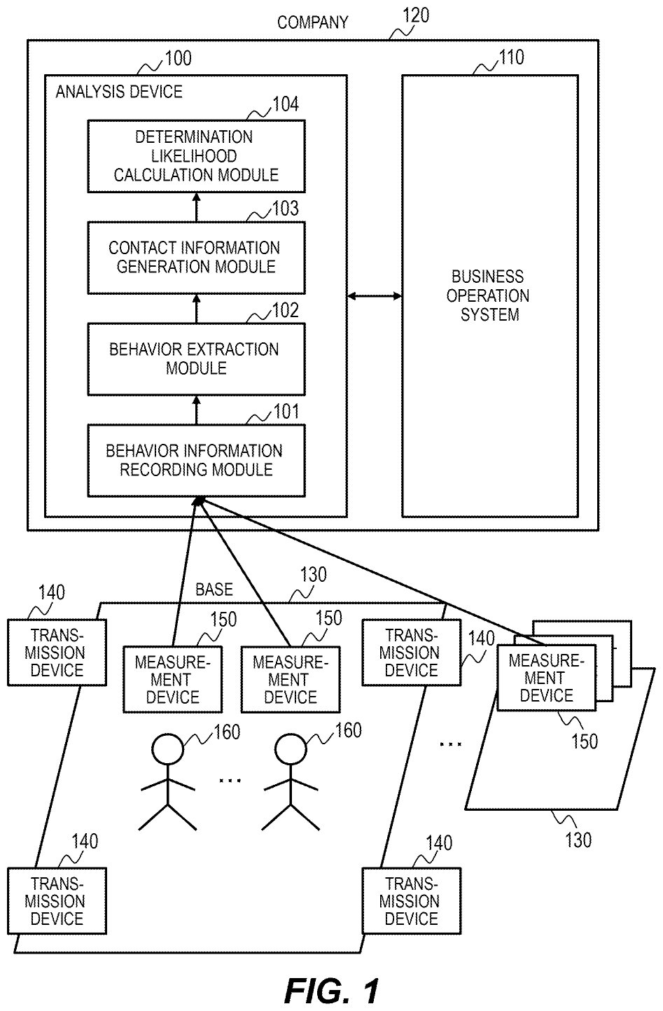

FIG. 1 is an explanatory diagram for illustrating an overall configuration of a contact determination system which achieves a solution in a first embodiment of this invention.

The system in the first embodiment is formed of an analysis device 100 and a business operation system 110 of a company 120, transmission devices 140 each arranged in a base 130, and measurement devices 150 each held by a person (for example, employee of the company 120) 160. Each base 130 is, for example, an office or a site of the company 120. A plurality of transmission devices 140 are installed in each base 130. The transmission device 140 is a device which transmits a wireless signal. The transmission device 140 may be, for example, a beacon which transmits a signal compliant with the Bluetooth, or may be a base station of a wireless local area network (LAN).

The measurement device 150 held by each person 160 is a terminal device having a function of measuring an intensity (radio wave intensity) of the wireless signal received from the transmission device 140, and transmitting a result thereof to the analysis device 100. The measurement device 150 may be, for example, a so-called smartphone.

The analysis device 100 is a device which analyzes information received from each measurement device 150, to thereby execute processing such as determination of a contact between persons. The analysis device 100 includes a behavior information recording module 101, a behavior extraction module 102, a contact information generation module 103, and a determination likelihood calculation unit 104. The behavior information recording module 101 records the information received from each measurement device 150. The behavior extraction module 102 extracts a behavior of each person 160 based on the recorded information. The contact information generation module 103 generates information on the contact between the persons based on the extracted behaviors. The determination likelihood calculation module 104 determines a likelihood of the information on the contact. Details of those modules are described later.

The business operation system 110 is a system for managing a business operation of the company 120, and may be the same as a related-art business operation system. For example, the business operation system 110 may manage information such as a workplace and a work time of each person.

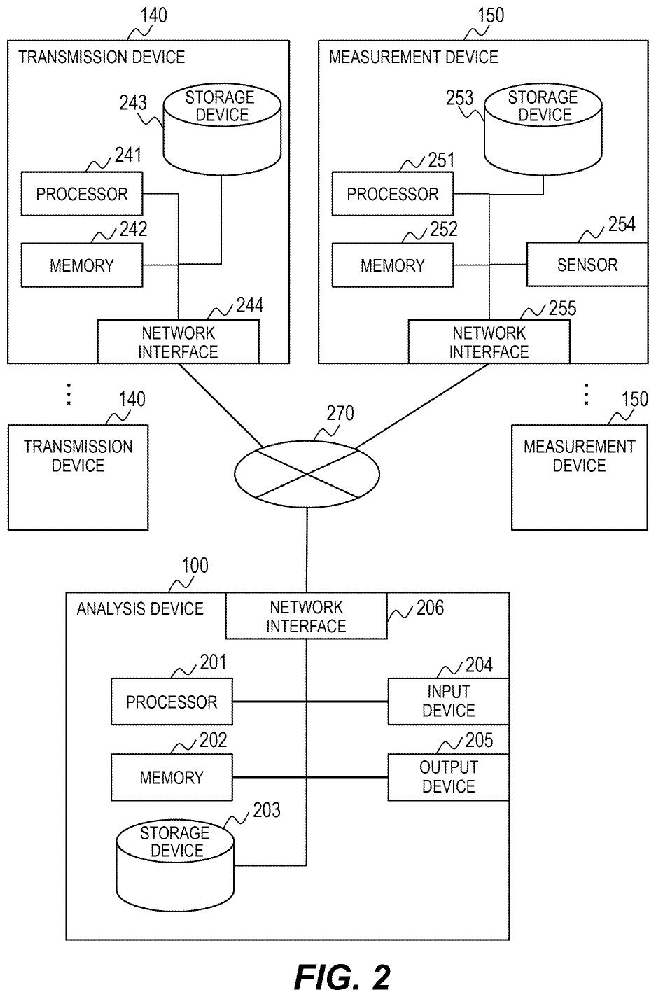

FIG. 2 is a block diagram for illustrating a hardware configuration of the contact determination system in the first embodiment.

The analysis device 100 includes a processor 201, a memory 202, a storage device 203, an input device 204, an output device 205, and a network interface 206.

The processor 201 controls each part of the analysis device 100 as required based on the program stored in the memory 202, to thereby execute various types of processing.

The memory 202 is a semiconductor memory, for example, a dynamic random access memory (DRAM), and stores the programs executed by the processor 201, data referred to in processing executed by the processor 201 in accordance with the programs, data generated as a result of the processing executed by the processor 201, and the like.

The storage device 203 is a storage device, for example, an HDD or an SSD, and stores various types of data used in the processing executed by the processor 201. For example, the above-mentioned programs and data may be stored in the storage device 203, and at least a part thereof may be copied to the memory 202 as required. Data updated on the memory 202 may be copied to the storage device 203 as required.

The input device 204 is a device which receives input of information from a user of the analysis device 100, and may include at least any one of, for example, a keyboard, a mouse, and a touch panel.

The output device 205 is a device which outputs information to the user of the analysis device 100, and may include at least any one of, for example, an image display device and a printer.

The network interface 206 is coupled to a network 270, and communicates to/from the measurement devices 150 through the network 270.

The transmission device 140 is a device which transmits the wireless signal. The transmission device 140 includes a processor 241, a memory 242, a storage device 243, and a network interface 244.

The processor 241 controls each part of the transmission device 140 as required based on the program stored in the memory 242, to thereby execute various types of processing.

The memory 242 is a semiconductor memory, for example, a DRAM, and stores the programs executed by the processor 241, data referred to in processing executed by the processor 241 in accordance with the programs, data generated as a result of the processing executed by the processor 241, and the like.

The storage device 243 is a storage device, for example, an HDD or an SSD, and stores various types of data used in the processing executed by the processor 241. For example, the above-mentioned programs and data may be stored in the storage device 243, and at least a part thereof may be copied to the memory 242 as required. Data updated on the memory 242 may be copied to the storage device 243 as required.

The network interface 244 communicates to/from other devices through the network 270. For example, the network interface 244 may transmit a wireless signal compliant with the Bluetooth, or may transmit a wireless signal compliant with a standard for the wireless LAN.

The measurement device 150 is a device which measures the wireless signal transmitted from the transmission device 140. The measurement device 150 includes a processor 251, a memory 252, a storage device 253, a sensor 254, and a network interface 255.

The processor 251 controls each part of the measurement device 150 as required based on the program stored in the memory 252, to thereby execute various types of processing.

The memory 252 is a semiconductor memory, for example, a DRAM, and stores the programs executed by the processor 251, data referred to in processing executed by the processor 251 in accordance with the programs, data generated as a result of the processing executed by the processor 251, and the like.

The storage device 253 is a storage device, for example, an HDD or an SSD, and stores various types of data used in the processing executed by the processor 251. For example, the above-mentioned programs and data may be stored in the storage device 253, and at least a part thereof may be copied to the memory 252 as required. Data updated on the memory 252 may be copied to the storage device 253 as required.

The sensor 254 is a device which acquires some information from a periphery of the measurement device 150. In the first embodiment, the type of the sensor 254 is not limited, and may be a barcode reader, a quick response code (QR code, the same applies hereinafter) reader, a near field communication (NFC) reader, or the like.

The network interface 255 is coupled to the network 270, and communicates to/from the other devices through the network 270. For example, the network interface 255 communicates to/from the analysis device 100. Moreover, the network interface 255 receives the wireless signal transmitted from the transmission device 140.

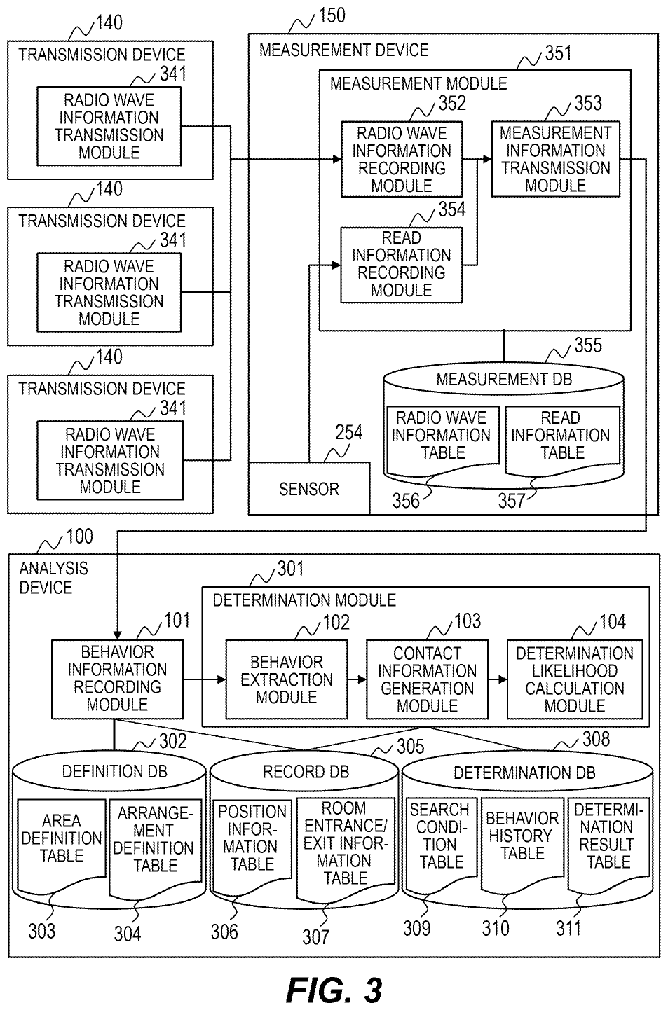

FIG. 3 is a block diagram for illustrating a logical configuration of the entire contact determination system in the first embodiment.

Each transmission device 140 includes a radio wave information transmission module 341. The radio wave information transmission module 341 is a function block implemented by the processor 241 of the transmission device 140 executing the program stored in the memory 242. In other words, processing executed by the radio wave information transmission module 341 in the following description is actually executed by the processor 241 in accordance with the program stored in the memory 242. The radio wave information transmission module 341 transmits a predetermined wireless signal (radio wave information) at a predetermined timing (for example, periodically or always). The information to be transmitted may include identification information on each transmission device 140 which transmits the information.

The measurement device 150 includes a measurement module 351 and a measurement database (DB) 355. The measurement module 351 includes a radio wave information recording module 352, a read information recording module 354, and a measurement information transmission module 353. The radio wave information recording module 352 records the radio wave information received from the transmission device 140. The read information recording module 354 records the information read by the sensor 254. The measurement information transmission module 353 transmits those pieces of information to the analysis device 100. The measurement module 351 is a function block implemented by the processor 251 of the measurement device 150 executing the program stored in the memory 252. In other words, processing executed by the measurement module 351 in the following description is actually executed by the processor 251 in accordance with the program stored in the memory 252.

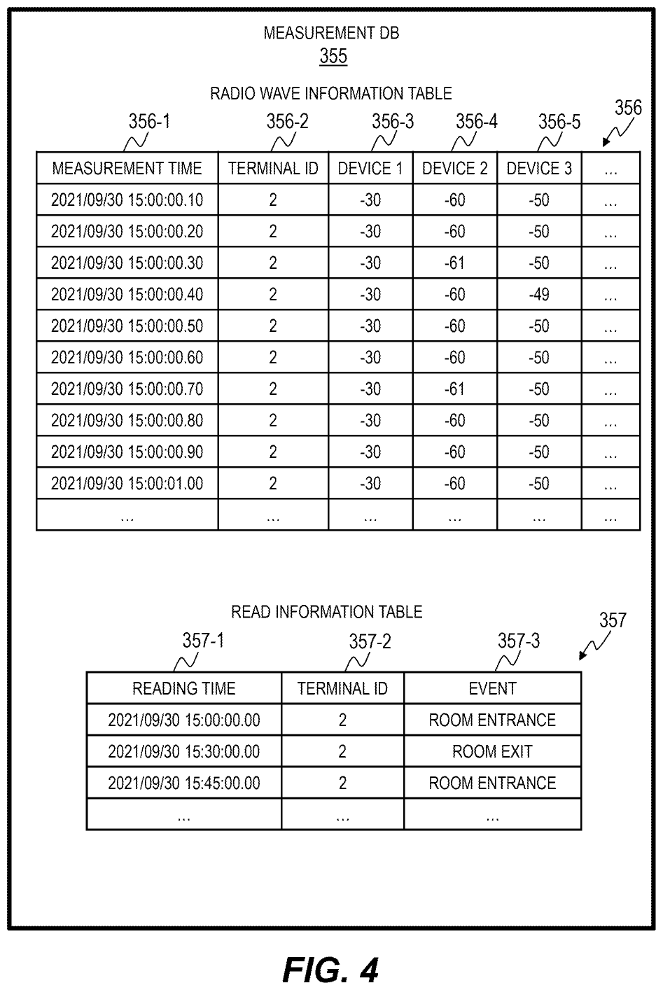

The measurement DB 355 is stored in the storage device 253 of the measurement device 150. The measurement DB 355 includes a radio wave information table 356 and a read information table 357. The radio wave information table 356 records the radio wave information received from the transmission device 140. The read information table 357 records the information read by the read information recording module 354. Details of those tables are described later with reference to FIG. 4.

The analysis device 100 includes the behavior information recording module 101, a determination module 301, a definition DB 302, a record DB 305, and a determination DB 308. The determination module 301 includes the behavior extraction module 102, the contact information generation module 103, and the determination likelihood calculation module 104. Both of the behavior information recording module 101 and the determination module 301 are function blocks implemented by the processor 201 of the analysis device 100 executing the programs stored in the memory 202. In other words, processing executed by the behavior information recording module 101 and the determination module 301 in the following description is actually executed by the processor 201 in accordance with the programs stored in the memory 202.

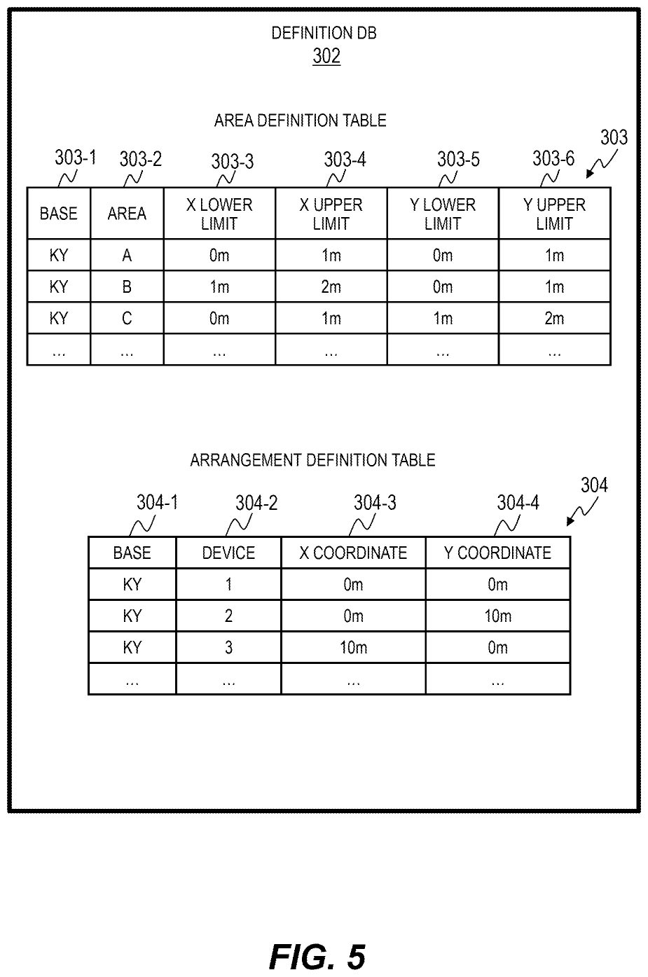

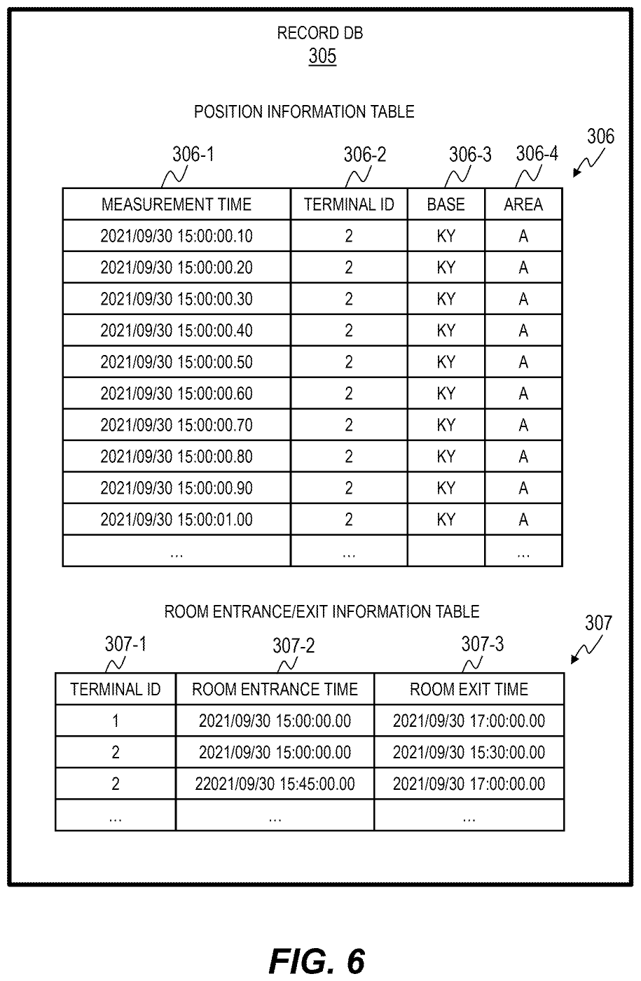

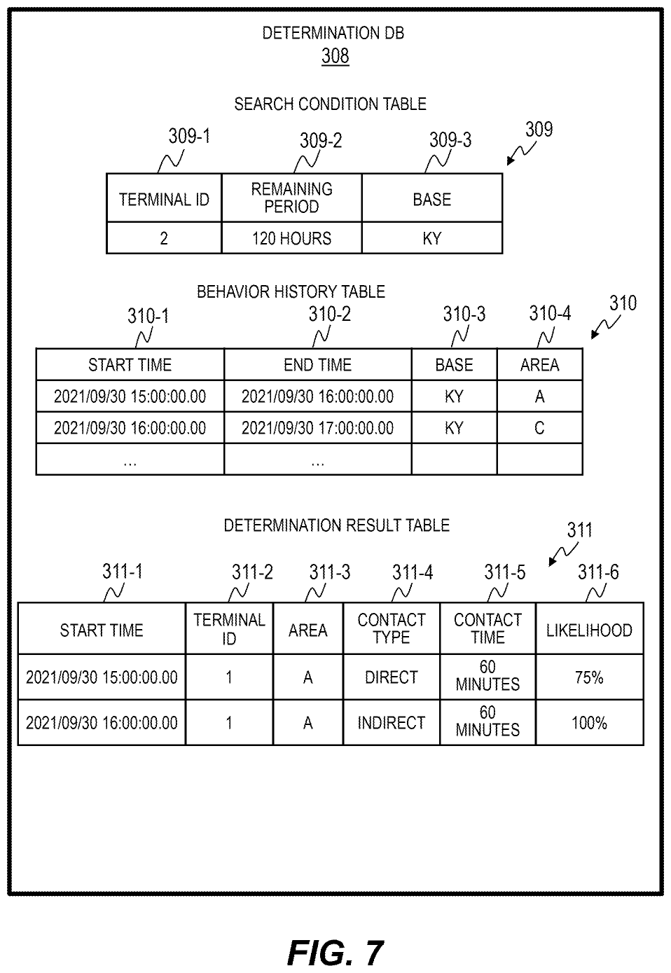

The definition DB 302, the record DB 305, and the determination DB 308 are stored in the storage device 203 of the analysis device 100. The definition DB 302 includes an area definition table 303 and an arrangement definition table 304. Details of those tables are described later with reference to FIG. 5. The record DB 305 includes a position information table 306 and a room entry/exit information table 307. Details of those tables are described later with reference to FIG. 6. The determination DB 308 includes a search condition table 309, a behavior history table 310, and a determination result table 311. Details of those tables are described later with reference to FIG. 7.

FIG. 4 is an explanatory diagram for illustrating configurations of the tables stored in the measurement DB 355 in the first embodiment.

As illustrated in FIG. 3, the radio wave information table 356 and the read information table 357 are stored in the measurement DB 355. As illustrated in FIG. 4, the radio wave information table 356 includes, for example, a plurality of records each corresponding to a result of one time of measurement. Each record is formed of a measurement time 356-1, a terminal ID 365-2, and a measurement result of each of the transmission devices (for example, a reception radio wave intensity 356-3 of a wireless signal from a first transmission device 140, a reception radio wave intensity 356-4 of a wireless signal from a second transmission device 140, and a reception radio wave intensity 356-5 of a wireless signal from a third transmission device 140).

The measurement time 356-1 indicates a time at which the measurement device 150 carried out the measurement (that is, the reception of the wireless signal from each transmission device 140). The terminal ID 356-2 indicates the identification information on the measurement device 150 which carried out the measurement. Each of the reception radio wave intensities 356-3 to 356-5 and the like indicates the radio wave intensity of the wireless signal from each transmission device 140 received by the measurement device 150. When the measurement device 150 actually receives the wireless signals from more transmission devices 140, which is omitted in FIG. 4, reception radio wave intensities corresponding to those transmission devices 140 are also recorded in the radio wave information table 356.

As illustrated in FIG. 4, the read information table 357 includes, for example, a plurality of records each corresponding to a result of one time of reading. Each record is formed of a reading time 357-1, a terminal ID 357-2, and an event 357-3.

The reading time 357-1 indicates a time at which the measurement device 150 executed the reading of information (for example, reading of a barcode, reading of a QR code, or reading of wireless tag information or the like through the NFC) through the sensor 254. The terminal ID 357-2 indicates the identification information on the measurement device 150 which executed the reading of the information through the sensor 254. The event 357-3 indicates an event identified from a result of the reading of the information by the sensor 254.

For example, when the base 130 is an office of the company 120, a tag (for example, a QR code or a wireless tag) corresponding to this base 130 is installed at an entrance thereof, and the sensor 254 reads tag information when a person 160 enters and exits from the office, events corresponding thereto such as a room entry and a room exit are recorded in the event 357-3.

The read information table 357 may be generated for each base 130, and may be stored in the measurement DB 355. In FIG. 4, information on any one (for example, a base “KY” described later) of the bases 130 is illustrated as an example. Each record of the read information table 357 may further include information for identifying a base corresponding thereto, which is not shown in FIG. 4.

FIG. 5 is an explanatory diagram for illustrating configurations of the tables stored in the definition DB 302 in the first embodiment.

As illustrated in FIG. 3, the area definition table 303 and the arrangement definition table 304 are stored in the definition DB 302. As illustrated in FIG. 5, the area definition table 303 includes, for example, a plurality of records each corresponding to one of the areas in the base 130. Each record is formed of a base 303-1, an area 303-2, an X lower limit 303-3, an X upper limit 303-4, a Y lower limit 303-5, and a Y upper limit 303-6.

The base 303-1 indicates identification information on the base 130 for which an area is defined. The area 303-2 indicates identification information on the defined area. The X lower limit 303-3, the X upper limit 303-4, the Y lower limit 303-5, and the Y upper limit 303-6 indicate a range of the area. In other words, a range of from the X lower limit 303-3 to the X upper limit 303-4 in an X coordinate and from the Y lower limit 303-5 to the Y upper limit 303-6 in a Y coordinate is a range of this area.

As illustrated in FIG. 5, the arrangement definition table 304 includes, for example, a plurality of records each corresponding to one of the transmission devices 140. Each record is formed of a base 304-1, a device 304-2, an X coordinate 304-3, and a Y coordinate 304-4.

The base 304-1 indicates the identification information on the base 130 for which the areas are defined. The device 304-2 indicates identification information on each transmission device 140 installed in the base 130. The X coordinate 304-3 and the Y coordinate 304-4 indicate an arrangement of each transmission device 140 in the base 130.

FIG. 6 is an explanatory diagram for illustrating configurations of the tables stored in the record DB 305 in the first embodiment.

As illustrated in FIG. 3, the position information table 306 and the room entry/exit information table 307 are stored in the record DB 305. As illustrated in FIG. 6, the position information table 306 includes, for example, a plurality of records each corresponding to a result of one time of measurement. Each record is formed of a measurement time 306-1, a terminal ID 306-2, a base 306-3, and an area 306-4.

The measurement time 306-1 indicates a time at which the measurement device 150 executed the measurement. The terminal ID 306-2 indicates the identification information on the measurement device 150 which executed he measurement. The base 306-3 indicates the identification information on the base 130. The area 306-4 indicates the identification information on the area in the base 130. For example, a first record of the position information table 306 of FIG. 6 indicates that such position information that a measurement device 150 (that is, a person 160 holding this measurement device 150) having a terminal ID of “2” existed in an area “A” (that is, an area identified by “A”) of the base “KY” (that is, the base 130 identified by “KY”) at 15:00:00.10 on Sep. 30, 2021 is calculated from the radio wave intensities measured by this measurement device 150 at this time.

As illustrated in FIG. 6, the room entry/exit information table 307 includes, for example, a plurality of records each corresponding to a stay period of a person in the base 130. Each record is formed of a terminal ID 307-1, a room entry time 307-2, and a room exit time 307-3.

The terminal ID 307-1 indicates the identification information on the measurement device 150. The room entry time 307-2 and the room exit time 307-3 indicate a time at which the measurement device 150 (that is, a person 160 holding the measurement device 150) entered the base 130 and a time at which the measurement device 150 exited from the base 130, respectively. For example, a second record of the room entry/exit information table 307 of FIG. 6 indicates such room entry/exit information that the measurement device 150 having the terminal ID of “2” (that is, a person 160 holding this measurement device 150) entered the base “KY” at 15:00:00 on Sep. 30, 2021 and exited from the base “KY” at 17:00:00 on Sep. 30, 2021 is calculated from the read information of the sensor 254 of this measurement device 150.

The room entry/exit information table 307 may be generated for each base 130, and may be stored in the record DB 305. In FIG. 6, information on the base “KY” is illustrated as an example. Each record of the room entry/exit information table 307 may further include information for identifying a base corresponding thereto, which is not shown in FIG. 6.

Moreover, the room entry/exit information table 307 includes the information on the time of entry and the time of exit to and from the base 130, and is an example of information on a time of entry and a time of exit of each person 160 to and from a predetermined region including the areas. The predetermined region in this case may be any region as long as the region includes the areas. For example, a QR code or the like corresponding to each of regions (for example, a partition in a room, a conference room, and a working booth) obtained by dividing one base 130 may be set for the region, and the time of entry and the time of exit to and from each region may be recorded by reading the QR code or the like.

FIG. 7 is an explanatory diagram for illustrating configurations of the tables stored in the determination DB 308 in the first embodiment.

As illustrated in FIG. 3, the search condition table 309, the behavior history table 310, and the determination result table 311 are stored in the determination DB 308. The search condition table 309 is a table which holds a search condition for data to be processed, and is formed of, for example, a terminal ID 309-1, a remaining period 309-2, and a base 309-3.

For example, when it is found out that a person 160 holding a certain measurement device 150 having the terminal ID of “2” is infected by a certain virus (for example, the novel coronavirus), and it is required to extract other persons 160 who have directly or indirectly come into contact with the person 160, “2” is recorded in the terminal ID 309-1. When the workplace of this person 160 is the base 130 identified by the ID “KY,” “KY” is recorded in the base 309-3. When a period in which influence of this virus remains (for example, a period in which infectivity remains after this virus is discharged from an infected person) is 120 hours, “120 hours” is recorded in the remaining period 309-2.

It should be noted that, although description is given of a virus in the first embodiment, the virus is described as an example of a pathogen having infectivity, and this invention can also be applied to a pathogen other than the virus.

In the behavior history table 310, as a behavior history of this person identified from a search result based on the search condition table 309 (person 160 holding the measurement device 150 having the terminal ID of “2” in the example of FIG. 7), information indicating a history of a location of this person in each time period identified from the position information is recorded. For example, the behavior history table 310 is formed of start times 310-1, end times 310-2, bases 310-3, and areas 310-4.

The start time 310-1 and the end time 310-2 indicate a start time and an end time of each time period, respectively. The base 310-3 and the area 310-4 indicate a base 130 and an area to which a position identified as the location of this person belongs in each time period, respectively. For example, a first record of the behavior history table 310 of FIG. 7 indicates that it is identified that the person 160 holding the measurement device 150 having the terminal ID of “2” existed in the area “A” of the base “KY” in a time period of from 15:00:00 on Sep. 30, 2021 to 16:00:00 on the same day.

In the determination result table 311, information indicating each result of determination of presence or absence of a contact of this person with another person identified based on behavior histories of and the room entry/exit information on this person and the another person and a likelihood thereof is recorded. For example, the determination result table 311 is formed of start times 311-1, terminal IDs 311-2, areas 311-3, contact types 311-4, contact times 311-5, and likelihoods 311-6.

The start time 311-1 indicates a start time of a period in which it is determined that this person (in the example of FIG. 7, the person 160 holding the measurement device 150 having the terminal ID of “2”) and another person were in contact with each other. The terminal ID 311-2 indicates the identification information on a measurement device 150 held by the another person. The area 311-3 indicates the identification information on an area in which the determined contact occurred.

The contact type 311-4 indicates a type of the determined contact. For example, the contact type 311-4 is information indicating any one of the direct contact and the indirect contact. For example, it is determined that a direct contact occurred when this person and the another person were in the same area in the same time period. It is determined that an indirect contact occurred when this person and the another person were in the same area in time periods which are different from each other and satisfy a predetermined condition. For example, after this person had stayed in a certain area, when the another person stayed in this area before the time indicated in the remaining period 309-2 had elapsed, it is determined that an indirect contact occurred.

The contact time 311-5 indicates a length of the time in which this person and the another person are determined to be in contact with each other. The likelihood 311-6 indicates a likelihood of the determination for the contact. Calculation of the likelihood 311-6 is described later.

For example, a first record of the determination result table 311 of FIG. 7 indicates that it is determined that the person 160 holding the measurement device 150 having the terminal ID of “2” and a person 160 holding a measurement device 150 having a terminal ID of “1” were directly in contact with each other in the area “A” for one hour from 15:00:00 on Sep. 30, 2021 and the likelihood thereof is 75%.

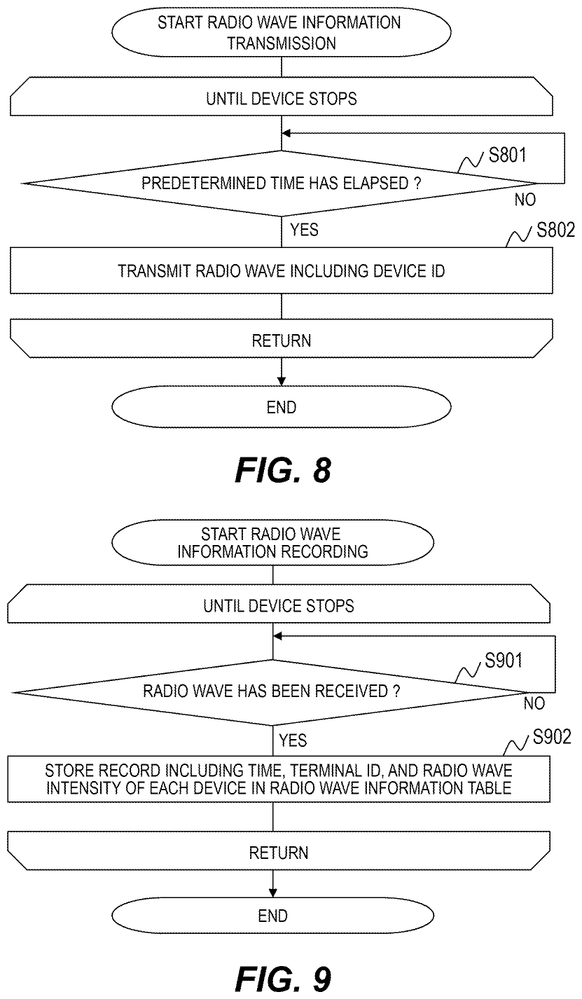

FIG. 8 is a flowchart for illustrating processing executed by the radio wave information transmission module 341 of the transmission device 140 in the first embodiment.

After the radio wave information transmission module 341 starts the processing, the radio wave information transmission module 341 repeatedly executes Step S801 and Step S802 described below until the transmission device 140 stops.

First, the radio wave information transmission module 341 determines whether or not a predetermined time has elapsed (Step S801). When the predetermined time has not elapsed, the radio wave transmission module 341 waits until the predetermined time elapses. When the predetermined time has elapsed, the radio wave information transmission module 341 transmits a predetermined radio wave including a device ID which identifies this transmission device 140 (Step S802). The radio wave transmitted in this case may be, for example, a radio wave compliant with the Bluetooth or a radio wave compliant with a standard of the wireless LAN. When the transmission device 140 stops, the processing of the radio wave information transmission module 341 is finished.

FIG. 9 is a flowchart for illustrating processing executed by the radio wave information recording module 352 of the measurement device 150 in the first embodiment.

After the radio wave information recording module 352 starts the processing, the radio wave information recording module 352 repeatedly executes Step S901 and Step S902 described below until the measurement device 150 stops.

First, the radio wave information recording module 352 determines whether or not the radio wave has been received (Step S901). When the radio wave has not been received, the radio wave information recording module 352 waits until the radio wave is received. When the radio wave has been received, the radio wave information recording module 352 stores, in the radio wave information table 356, a record including a reception time of this radio wave, a terminal ID identifying this measurement device 150, and a device ID identifying a transmission device 140 which has transmitted this radio wave (Step S902). When the measurement device 150 receives the radio waves from a plurality of transmission devices 140, a radio wave intensity of each of the transmission devices 140 is stored. When the measurement device 150 stops, the processing of the radio wave information recording module 352 is finished.

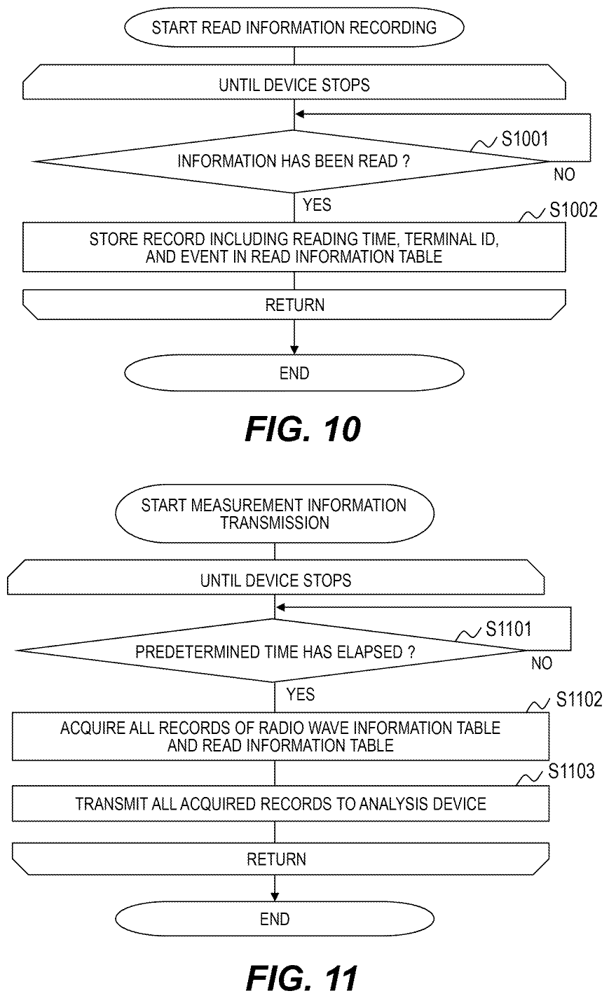

FIG. 10 is a flowchart for illustrating processing executed by the read information recording module 354 of the measurement device 150 in the first embodiment.

After the read information recording module 354 starts the processing, the read information recording module 354 repeatedly executes Step S1001 and Step S1002 described below until the measurement device 150 stops.

First, the read information recording module 354 determines whether or not the sensor 254 has read information (Step S1001). When information has not been read, the read information recording module 354 waits until information is read. When information has been read, the read information recording module 354 stores, in the read information table 357, a record including a reading time of this information, a terminal ID identifying this measurement device 150, and information indicating an event identified based on the read information (Step S1002). When the measurement device 150 stops, the processing of the read information recording module 354 is finished.

FIG. 11 is a flowchart for illustrating processing executed by the measurement information transmission module 353 of the measurement device 150 in the first embodiment.

After the measurement information transmission module 353 starts the processing, the measurement information transmission module 353 repeatedly executes Step S1101 and Step S1102 described below until the measurement device 150 stops.

First, the measurement information transmission module 353 determines whether or not a predetermined time has elapsed (Step S1101). When the predetermined time has not elapsed, the measurement information transmission module 331 waits until the predetermined time elapses. When the predetermined time has elapsed, the measurement information transmission module 353 acquires all records in the radio wave information table 356 and the read information table 357 (Step S1102), and transmits the acquired all records to the analysis device 100 (Step S1103). When the measurement device 150 stops, the processing of the measurement information transmission module 353 is finished.

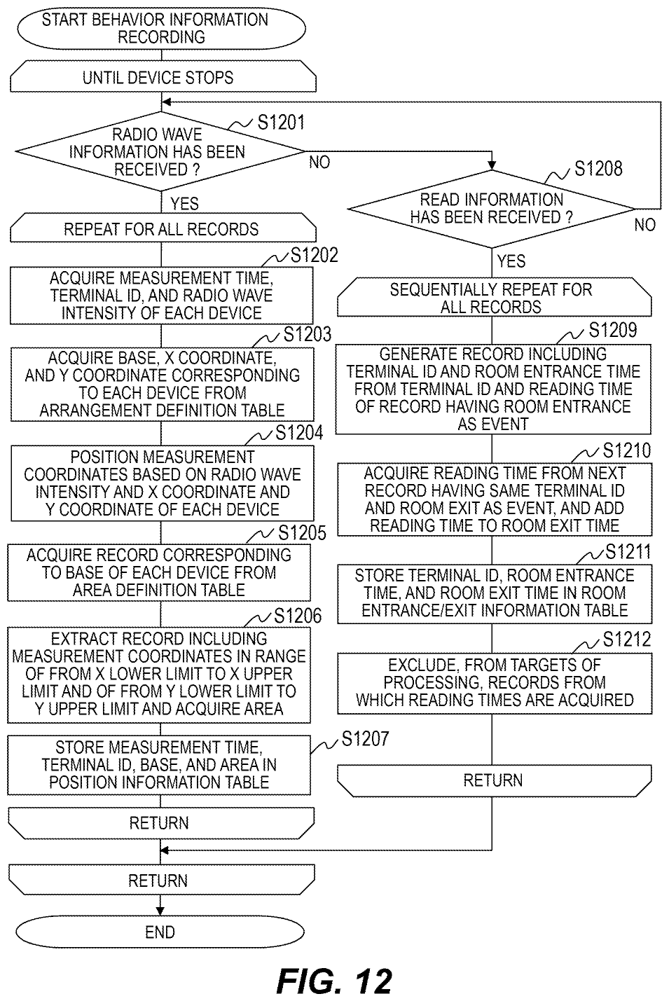

FIG. 12 is a flowchart for illustrating processing executed by the behavior information recording module 101 of the analysis device 100 in the first embodiment.

After the behavior information recording module 101 starts the processing, the behavior information recording module 101 repeatedly executes Step S1201 to Step S1212 described below until the analysis device 100 stops.

First, the behavior information recording module 101 determines whether or not the radio wave information (that is, the information of the records in the radio wave information table 356) has been received from the measurement device 150 (Step S1201). When the radio wave information has been received, the behavior information recording module 101 repeatedly executes Step S1202 to Step S1207 for all records included in the received radio wave information. When the radio wave information has not been received, the behavior information recording module 101 determines whether or not the read information (that is, information of the records in the read information table 357) has been received from the measurement device 150 (Step S1208). When the read information has been received, the behavior information recording module 101 repeatedly executes Step S1209 to Step S1212 for all records included in the received read information.

It should be noted that the determination of whether or not the radio wave information has been received and the determination of whether or not the read information has been received may be executed based on a file name of the received data or with reference to contents of columns included in the received data. Moreover, the received radio wave information and read information may temporarily be stored in the storage device 203.

When it is determined that the radio wave information has been received in Step S1201, the behavior information recording unit 101 acquires, from the record included in the received radio wave information, the measurement time 356-1, the terminal ID 356-2, the radio wave intensities 356-3 to 356-5 from the respective transmission devices 140, and the like (Step S1202). After that, the behavior information recording module 101 acquires the base 304-1, the X coordinate 304-3, and the Y coordinate 304-4 corresponding to each transmission device 140 being the transmission source of the received radio wave from the arrangement definition table 304 (Step S1203).

After that, the behavior information recording module 101 positions coordinates (hereinafter also referred to as “measurement coordinates”) of the measurement device 150 based on the acquired radio wave intensity and the coordinate values of each transmission device 140 (Step S1204). A method of the positioning is not limited to a specific method, and any method can be used. For example, a publicly-known three-point positioning may be used, or a model generated through machine learning with use of the radio wave intensity as a feature amount may be used.

After that, the behavior information recording module 101 acquires, from the area definition table 303, records corresponding to the base in which the transmission devices 140 are arranged (Step S1205). After that, the behavior information recording module 101 extracts, from the records acquired in Step S1205, a record which includes the measurement coordinates in a range of from the X lower limit 303-3 to the X upper limit 303-4 and from the Y lower limit 303-5 to the Y upper limit 303-6, and acquires the value of the area 303-2 of the extracted record.

After that, the behavior information recording module 101 stores, in the position information table 306, the measurement time, the terminal ID, the base, and the acquired area.

When it is determined that read information has been received in Step S1208, the behavior information recording module 101 acquires, out of the records of the received read information, a record which has the room entry in the event 357-3, and generates a record including the values of the reading time 357-1 and the terminal ID 357-2 of this record as the room entry time and the terminal ID, respectively (Step S1209). After that, the behavior information recording module 101 acquires a record which is next to the record acquired in Step S1209 and has the room exit in the event 357-3, and adds, as the room exit time, the value of the reading time 357-1 of this record to the record generated in Step S1209 (Step S1210).

After that, the behavior information recording module 101 stores the record generated in Step S1209 and Step S1210 in the room entry/exit information table 307 (Step S1211). After that, the behavior information recording module 101 excludes, from targets of subsequent processing, out of the records of the received read information, the records each of which has the reading time 357-1 acquired through the above-mentioned processing (Step S1212).

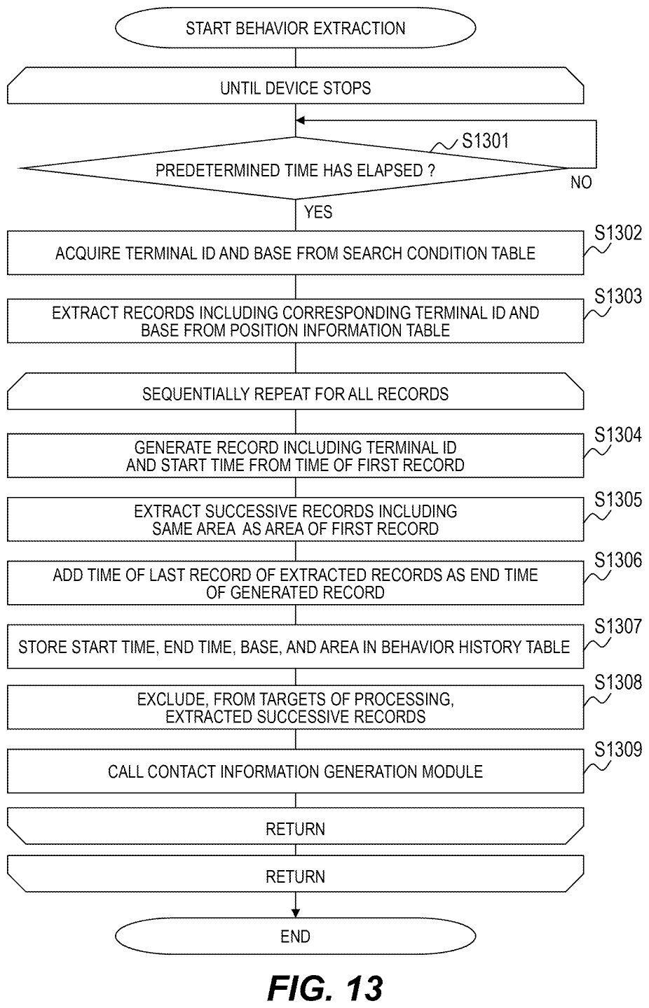

FIG. 13 is a flowchart for illustrating processing executed by the behavior extraction module 102 of the analysis device 100 in the first embodiment.

After the behavior extraction module 102 starts the processing, the behavior extraction module 102 repeatedly executes Step S1301 to Step S1309 described below until the analysis device 100 stops.

First, the behavior extraction module 102 determines whether or not a predetermined time has elapsed (Step S1301). When the predetermined time has not elapsed, the behavior extraction module 102 waits until the predetermined time elapses. When the predetermined time has elapsed, the behavior extraction module 102 acquires, from the search condition table 309, the values of the terminal ID 309-1 and the base 309-3 (Step S1302). After that, the behavior extraction module 102 extracts, from the position information table 306, records having the values of the terminal ID 306-2 and the base 306-3 corresponding to the values acquired in Step S1302 (Step S1303). After that, the behavior extraction module 102 repeatedly executes Step S1304 to Step S1309 for all of the extracted records.

The behavior extraction module 102 generates a record which includes the value of the measurement time 306-1 of a first record of the acquired records (that is, the earliest value of the measurement times 306-1 of the acquired records) as the start time, and further includes the values of the terminal ID 309-1 and the base 309-3 acquired in Step S1302 (Step S1304). After that, the behavior extraction module 102 extracts, from the acquired records, records in a range in which the same area as the area in the area 306-4 of this first record continues (Step S1305). After that, the behavior extraction module 102 adds, as the end time, the value of the measurement time 306-1 of the last record of the records extracted in Step S1305 to the record generated in Step S1304 (Step S1306).

After that, the behavior extraction module 102 stores the start time, the end time, the base, and the terminal ID of the generated record in the behavior history table 310 (Step S1307). After that, the behavior extraction module 102 deletes the record extracted in Step S1303 and the successive records extracted in Step S1305 from the targets of the processing (Step S1308). This deletion may be executed by freeing those records from the memory, or adding a predetermined flag.

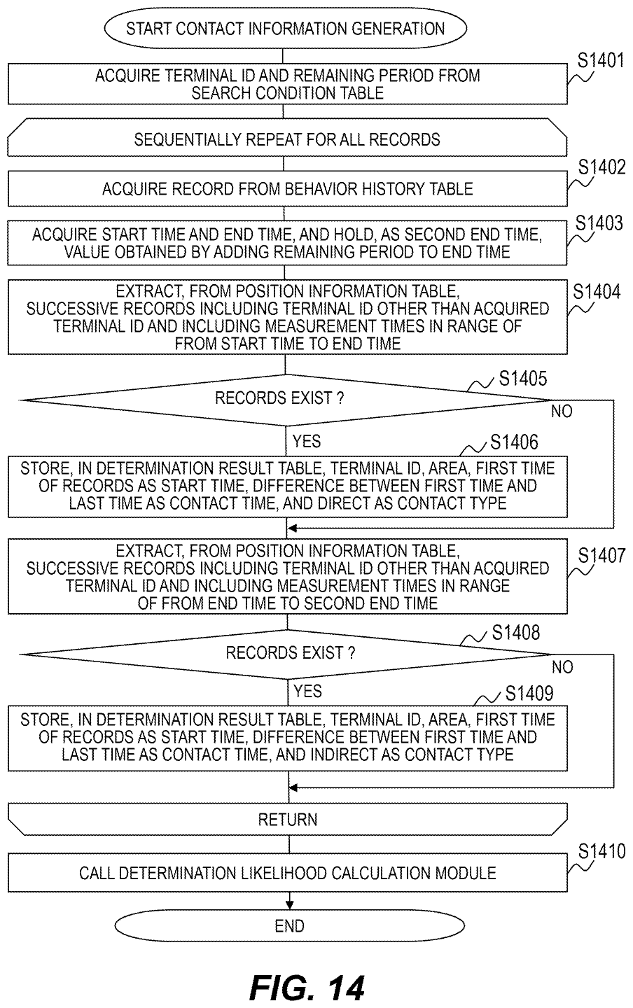

After that, the behavior extraction module 102 calls the contact information generation module 103 (Step S1309). Processing of the contact information generation module 103 is described later with reference to FIG. 14.

FIG. 14 is a flowchart for illustrating processing executed by the contact information generation module 103 of the analysis device 100 in the first embodiment.

First, the contact information generation module 103 acquires, from the search condition table 309, the values of the terminal ID 309-1 and the remaining period 309-2 (Step S1401).

After that, the contact information generation module 103 repeatedly executes Step S1402 to Step S1409 described below for all of the records of the behavior history table 310.

The contact information generation module 103 acquires one record from the behavior history table 310 (Step S1402). After that, the contact information generation module 103 acquires the values of the start time 310-1 and the end time 310-2 from this record, and holds, as a second end time, a value obtained by adding the value of the remaining period 309-2 to the value of the end time 310-2 (Step S1403).

After that, the contact information generation module 103 extracts, from the position information table 306, records each of which has a value of the terminal ID 306-2 different from the terminal ID acquired in Step S1401 and has a value of the measurement time 306-1 included in the range of from the start time 310-1 to the end time 310-2 of the record acquired in Step S1402 (Step S1404). In this case, when the position information table 306 includes a plurality of successive records which satisfy the above-mentioned conditions, the contact information generation module 103 extracts those successive records.

After that, the contact information generation module 103 determines whether or not one or more records are extracted in Step S1404 (Step S1405). When one or more records are extracted in Step S1404, the contact information generation module 103 stores, in the determination result table 311, a record which has the values of the terminal ID 306-2 and the area 306-4 of the extracted records as the terminal ID 311-2 and the area 311-3, respectively, has the value of the measurement time 306-1 of the first extracted record as the start time 311-1, has a difference between the values of the measurement times 306-1 of the first extracted record and the last extracted record as the contact time 311-5, and has “direct” as the contact type 311-4 (Step S1406). When one or more records are not extracted in Step S1404, the contact information generation module 103 does not execute Step S1406.

After that, the contact information generation module 103 extracts, from the position information table 306, records each of which has a value of the terminal ID 306-2 different from the terminal ID acquired in Step S1401, and has a value of the measurement time 306-1 included in the range of from the end time 310-2 to the second end time of the record acquired in Step S1402 (Step S1407). In this case, when the position information table 306 includes a plurality of successive records which satisfy the above-mentioned conditions, the contact information generation module 103 extracts those successive records.

After that, the contact information generation module 103 determines whether or not one or more records are extracted in Step S1407 (Step S1408). When one or more records are extracted in Step S1407, the contact information generation module 103 stores, in the determination result table 311, a record which has the values of the terminal ID 306-2 and the area 306-4 of the extracted records as the terminal ID 311-2 and the area 311-3, respectively, has the value of the measurement time 306-1 of the first extracted record as the start time 311-1, has a difference between the values of the measurement times 306-1 of the first extracted record and the last extracted record as the contact time 311-5, and has “indirect” as the contact type 311-4 (Step S1409). When one or more records are not extracted in Step S1407, the contact information generation module 103 does not execute Step S1409.

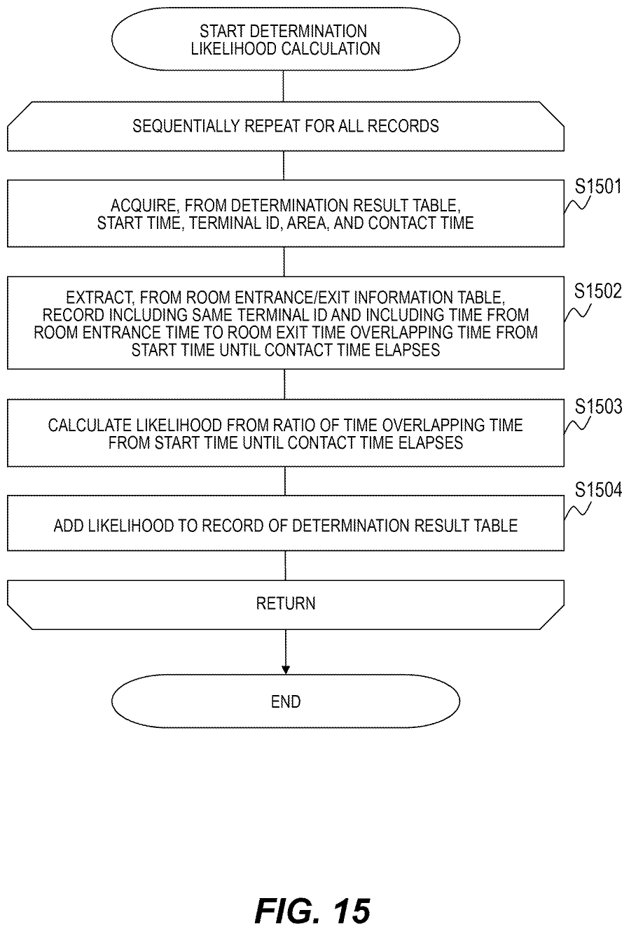

When Step S1402 to Step S1409 described above are finished for all of the records, the contact information generation module 103 calls the determination likelihood calculation module 104 (Step S1410). Processing of the determination likelihood calculation module 104 is described later with reference to FIG. 15.

FIG. 15 is a flowchart for illustrating processing executed by the determination likelihood calculation module 104 of the analysis device 100 in the first embodiment.

The determination likelihood calculation module 104 repeatedly executes Step S1501 to Step S1504 for all of the records of the determination result table 311.

First, the determination likelihood calculation module 104 acquires one record from the determination result table 311, and acquires values of the start time 311-1, the terminal ID 311-2, the area 311-3, and the contact time 311-5 of this record (Step S1501).

After that, the determination likelihood calculation module 104 extracts, from the room entry/exit information table 307, a record having the same ID 307-1 as that acquired in Step 1501 and having a time from the room entry time 307-2 to the room exit time 307-3 overlapping a time from the start time 311-1 acquired in Step 1501 until the contact time 311-5 acquired in Step 1501 elapses (Step S1502).

After that, the determination likelihood calculation module 104 calculates a likelihood based on a ratio of a length of an overlap portion between the time from the start time 311-1 to the time until the contact time 311-5 elapses and the time from the room entry time 307-2 to the room exit time 307-3 to the length of the time from the start time 311-1 to the time until the contact time 311-5 elapses (Step S1503). For example, the likelihood may be calculated so that the likelihood increases as the ratio of the length of the overlap portion is longer. After that, the determination likelihood calculation module 104 adds the calculated likelihood to the likelihood 311-6 of the record of the determination result table 311 which is acquired in Step S1501 (Step S1504).

With reference to FIG. 6 and FIG. 7, description is now given of an example of the calculation of the likelihood. A time which is in a first record of the determination result table 311 and is from the start time 311-1 until the contact time 311-5 elapses is one hour from 15:00:00 on Sep. 30, 2021 to 16:00:00 on the same day. This indicates that it is identified, based on the positioning result, that both of the person 160 (hereinafter also referred to as person “1”) holding the measurement device 150 having the terminal ID of “2” and the person 160 (hereinafter also referred to as person “2”) holding the measurement device 150 having the terminal ID of “1” stayed in the area “A” of the base “KY” in this one hour.

Meanwhile, the room entry times 307-2 and the room exit times 307-3 of second and third records of the room entry/exit information table 307 of FIG. 6 indicate that it is identified, based on the reading results of the sensor 254, that the stay times of the person “2” at the base “KY” are from 15:00:00 on Sep. 30, 2021 to 15:30:00 seconds on the same day and from 15:45:00 on the same day to 17:00:00 on the same day.

In other words, with respect to the stay time in one hour from 15:00:00 identified based on the positioning result, the stay time identified based on the reading result of the sensor 254 is 45 minutes obtained by totaling 30 minutes from 15:00:00 and 15 minutes from 15:45:00. Thus, a ratio thereof is 75%. As a cause of the mismatch between the stay time identified based on the positioning result and the stay time identified based on the reading result of the sensor 254 as described above, for example, an error in the positioning due to reflection of the radio wave and the like is given. It can be considered that as the mismatch therebetween becomes larger, the likelihood of the identification result becomes lower. For example, the above-mentioned ratio of 75% may directly be used as the value of the likelihood 311-6.

When the read information table 357 includes a time of the entry to and a time of the exit from the base “KY” as described above, it is possible to identify that each person 160 stayed at the base “KY” in a certain period from the read information, but it is not possible to identify in which area in the base “KY” the person 160 stayed in this period. However, when it is identified that the person 160 did not stay at the base “KY” from the read information, it is possible to identify that the person 160 stayed in none of areas of the base “KY” in this period. Thus, the likelihood may be calculated so that the likelihood decreases as the ratio of the overlap portion between the period (1 hour from 15:00:00 in the above-mentioned example) in which it is identified that this person 160 stayed in a certain area based on the positioning result and the period (15 minutes from 15:30:00 in the above-mentioned example) in which it is identified that this person 160 did not stay in this area based on the reading result of the sensor 254 increases.

The time from the start time 311-1 until the contact time 311-5 elapses of a second record of the determination result table 311 of FIG. 7 is one hour from 16:00:00 on Sep. 30, 2021 to 17:00:00 on the same day. Meanwhile, it is identified that the person “2” stayed at the base “KY” in one hour from 16:00:00 on Sep. 30, 2021 to 17:00:00 on the same day from the room entry times 307-2 and the room exit times 307-3 of the second and third records of the room entry/exit information table 307 of FIG. 6. That is, a ratio of the latter stay time to the former stay time is 100%, and the likelihood 311-6 is thus calculated as 100%.

In the first embodiment, as described above, the degree of the match between the stay time in each area based on the positioning result and the stay time based on the reading result of the sensor 254 is calculated as the likelihood. However, the stay time based on the reading result of the sensor 254 is an example of a stay time which is identified based on a business operation log, and is different from the stay time based on the positioning result. The likelihood may be calculated by collating the stay time based on other information corresponding the business operation log and the stay time based on the positioning result with each other.

As an example of the other information, an operation log at the time when each person 160 operates a PC used for the business operation and a behavior log of each person 160 based on a measurement value of an acceleration sensor worn by each person 160 are given, but another business operation log may be used. Moreover, as the business operation log, a plurality of pieces of information (for example, the operation log of the PC and the behavior log based on the measurement value of the acceleration sensor) may be used. In this case, each of the plurality of pieces of information may be weighted.

Moreover, when the room entry and the room exit of each person 160 are detected based on the reading result of the QR code or the like as described above, in place of the detection of the entry to and the exit from the base 130 (or in addition thereto), an entry to and an exit from a smaller section may be detected. For example, an entry to and an exit from a working booth or sitting at and leaving from a desk in the base 130 may be determined based on reading of a QR code or an NFC tag or the like. As a result, the likelihood can be calculated based on the information having a higher resolution.

### Second Embodiment

Description is now given of a second embodiment of this invention. Except for differences described below, each component of the system in the second embodiment has the same function as the component denoted by the same reference symbol in the first embodiment, and description thereof is therefore omitted.

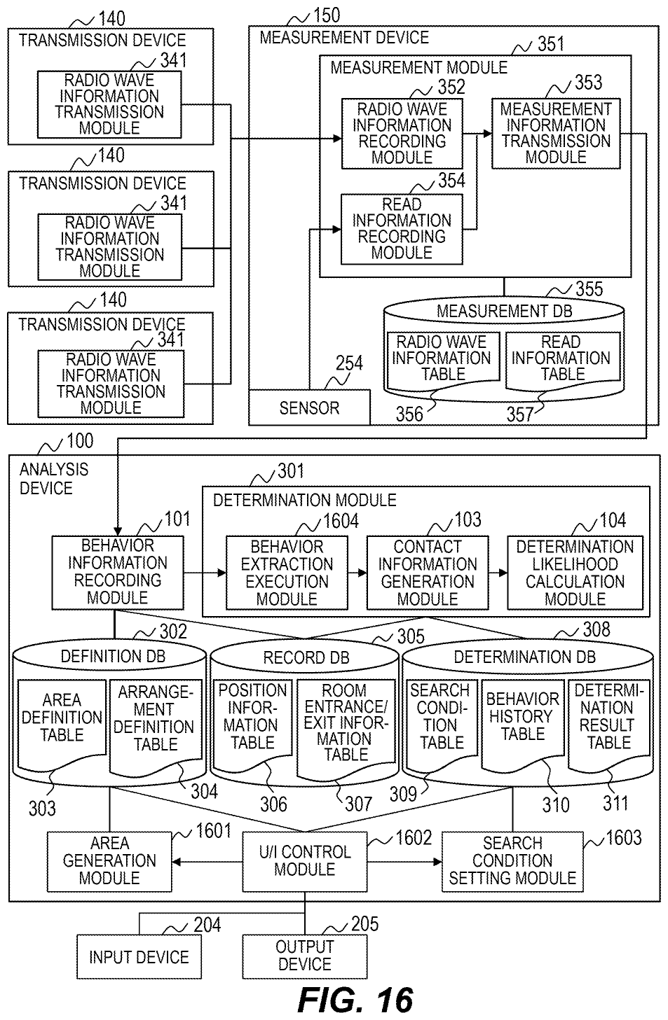

FIG. 16 is a block diagram for illustrating the logical configuration of the entire contact determination system in the second embodiment.

The contact determination system in the second embodiment is different from the contact determination system in the first embodiment in a point that the analysis device 100 includes an area generation module 1601, a user interface (U/I) control module 1602, and a search condition setting module 1603. In the second embodiment, processing executed by the area generation module 1601, the U/I control module 1602, and the search condition setting module 1603 is actually executed by the processor 201 in accordance with the programs stored in the memory 202. Moreover, the behavior extraction module 102 in the first embodiment is replaced by a behavior extraction execution module 1604 in the second embodiment.

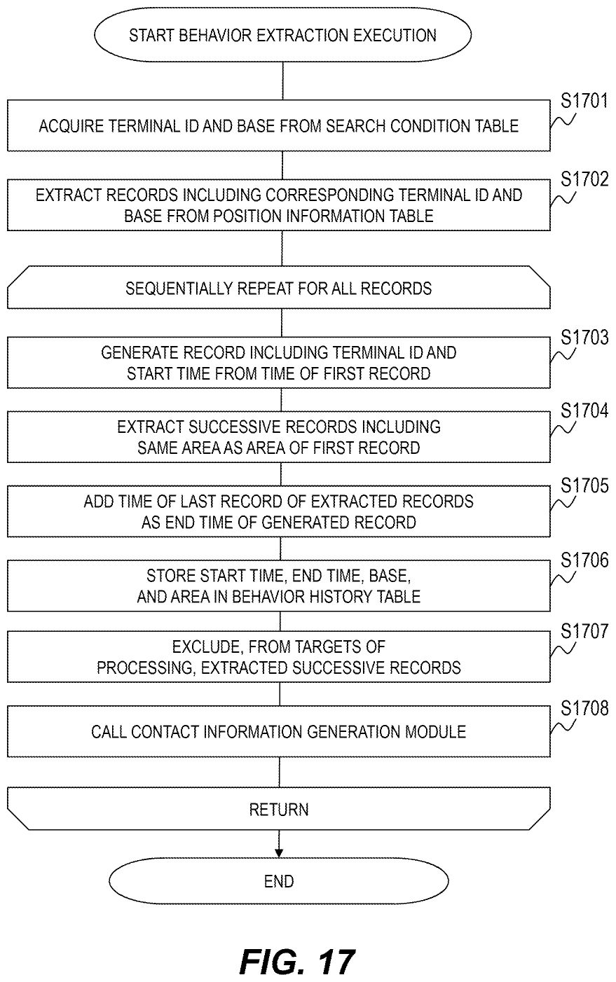

FIG. 17 is a flowchart for illustrating processing executed by the behavior extraction execution module 1604 of the analysis device 100 in the second embodiment.

Step S1701 to Step S1708 of FIG. 17 are equivalent to Step S1302 to Step S1309 of FIG. 13 executed by the behavior extraction module 102 in the first embodiment, respectively, and description thereof is therefore omitted. The processing of the behavior extraction module 102 is executed at the predetermined timing (for example, periodically) in the first embodiment, while in the second embodiment, the search condition is provided from the outside (for example, the user), and a start of the processing of the behavior extraction execution module 1604 is triggered by the provision of the search condition.

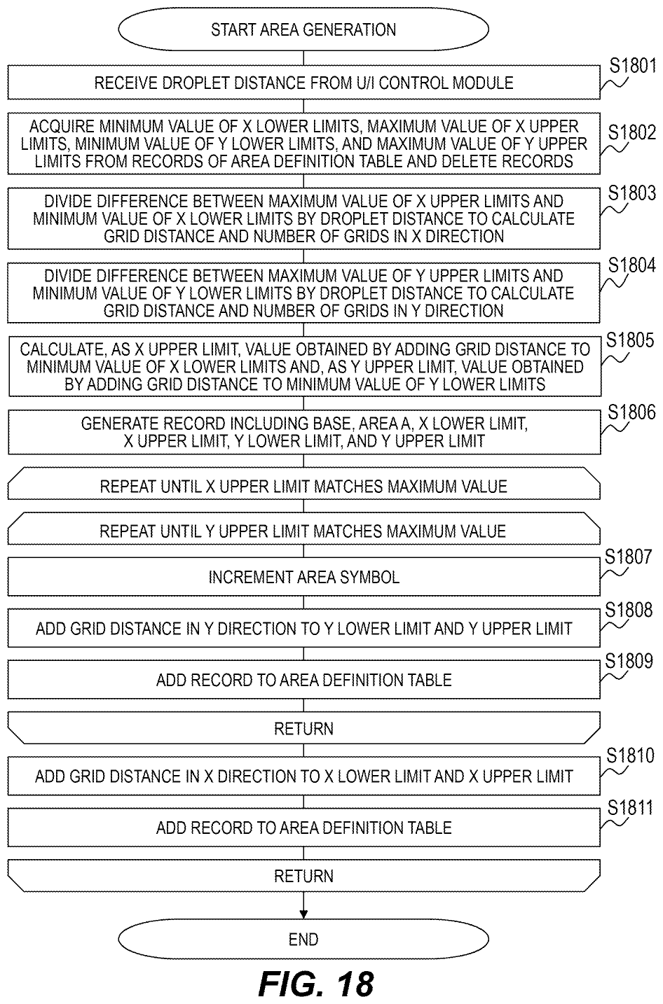

FIG. 18 is a flowchart for illustrating processing executed by the area generation module 1601 of the analysis device 100 in the second embodiment.

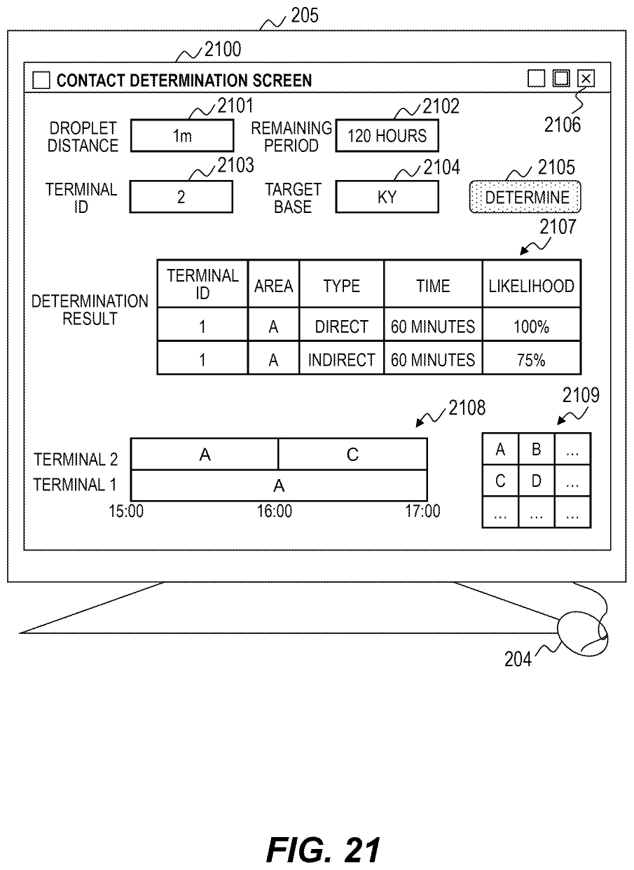

First, the area generation module 1601 receives information on a droplet distance from the U/I control module 1602 (Step S1801). In this case, the droplet distance indicates a distance between persons which can cause infection when scattering of droplets causes the infection in a virus infection disease of interest or the like. In more general, the droplet distance may be paraphrased into a distance over which the infectious pathogen discharged from the human body is scattered. For example, the droplet distance acquired by the U/I control module 1602 through the input device 204 may be passed to the area generation module 1601. An example of the acquisition of the information on the droplet distance by the U/I control module 1602 is described later with reference to FIG. 21.

After that, the area generation module 1601 acquires the minimum value of the X lower limits 303-3, the maximum value of the X upper limits 303-4, the minimum value of the Y lower limits 303-5, and the maximum value of the Y upper limits 303-6 from the records of the area definition table 303, and deletes all of the records (Step S1802).

After that, the area generation module 1601 divides a difference between the minimum value of the X lower limits 303-3 and the maximum value of the X upper limits 303-4 by the droplet distance, to thereby calculate a grid distance and the number of grids in the X direction (Step S1803). In this case, the grid distance in the X direction corresponds to the droplet distance.

After that, the area generation module 1601 divides a difference between the minimum value of the Y lower limits 303-5 and the maximum value of the Y upper limits 303-6 by the droplet distance, to thereby calculate a grid distance and the number of grids in the Y direction (Step S1804). In this case, the grid distance in the Y direction corresponds to the droplet distance.

After that, the area generation module 1601 calculates a value obtained by adding the grid distance to the minimum value of the X lower limits 303-3 as the X upper limit 303-4 corresponding to this X lower limit 303-3, and calculates a value obtained by adding the grid distance to the minimum value of the Y lower limits 303-5 as the Y upper limit 303-6 corresponding to this Y lower limit 303-5 (Step S1805). The area generation module 1601 then generates a record of the area definition table 303 including the values of those X lower limit 303-3, X upper limit 303-4, Y lower limit 303-5, and Y upper limit 303-6, the value of the corresponding area 303-2 (for example “A”), and the value of the corresponding base 303-1 (for example “KY”) (Step S1806).

After that, the area generation module 1601 increments the value of the area 303-2 (for example, increments “A” to “B”) (Step S1807), and adds the grid distance in the Y direction to each of the Y lower limit 303-5 and the Y upper limit 303-6 (Step S1808). The area generation module 1601 adds a record including those values to the area definition table 303 (Step S1809). The area generation module 1601 repeats Step S1807 to Step S1809 described above until the value of the Y upper limit 303-6 matches the maximum value of the Y upper limits 303-6 acquired in Step S1803.

After that, the area generation module 1601 adds the grid distance in the X direction to each of the X lower limit 303-3 and the X upper limit 303-4 (Step S1810). The area generation module 1601 adds a record including those values to the area definition table 303 (Step S1811). The area generation module 1601 repeats Step S1807 to Step S1811 described above until the value of the X upper limit 303-4 matches the maximum value of the X upper limits 303-4 acquired in Step S1803.

As a result, the areas in the grid form having a size corresponding to the droplet distance are defined. In the above-mentioned example, the grid distance matches the droplet distance, but the grid distance is generally set to be longer as the droplet distance is longer. As a result, it is possible to achieve appropriate contact determination for evaluating a risk of infection of, for example, a virus.

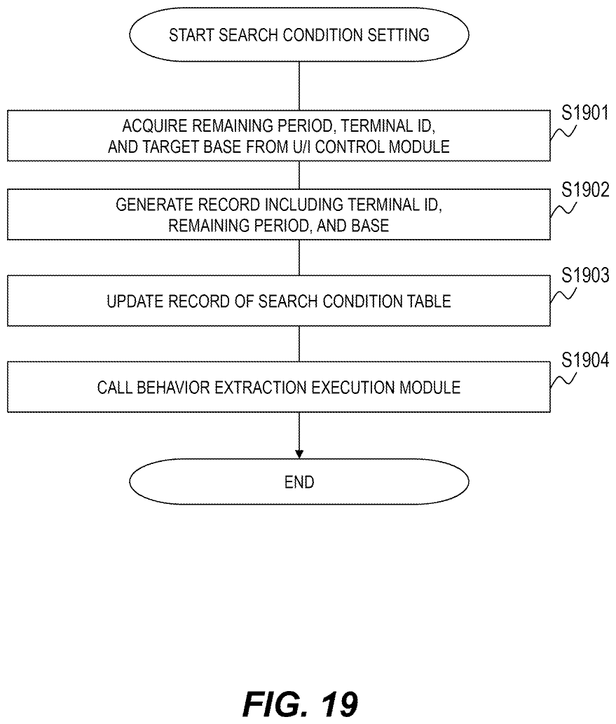

FIG. 19 is a flowchart for illustrating processing executed by the search condition setting module 1603 of the analysis device 100 in the second embodiment.

First, the search condition setting module 1603 receives information on the remaining period, the terminal ID, and the target base from the U/I control module 1602 (Step S1901). For example, the droplet distance acquired by the U/I control module 1602 through the input device 204 may be passed to the area generation module 1601. An example of the acquisition of the information on the remaining period, the terminal ID, and the target base by the U/I control module 1602 is described later with reference to FIG. 21.

After that, the search condition setting module 1603 generates a record including the received remaining period, terminal ID, and target base as the remaining period 309-2, the terminal ID 309-1, and the base 309-3, respectively (Step S1902), and uses this record to update the record of the search condition table 309 (Step 1903). The search condition setting module 1603 then calls the behavior extraction execution module 1604 (Step S1904). The behavior extraction execution module 1604 executes processing of FIG. 17.

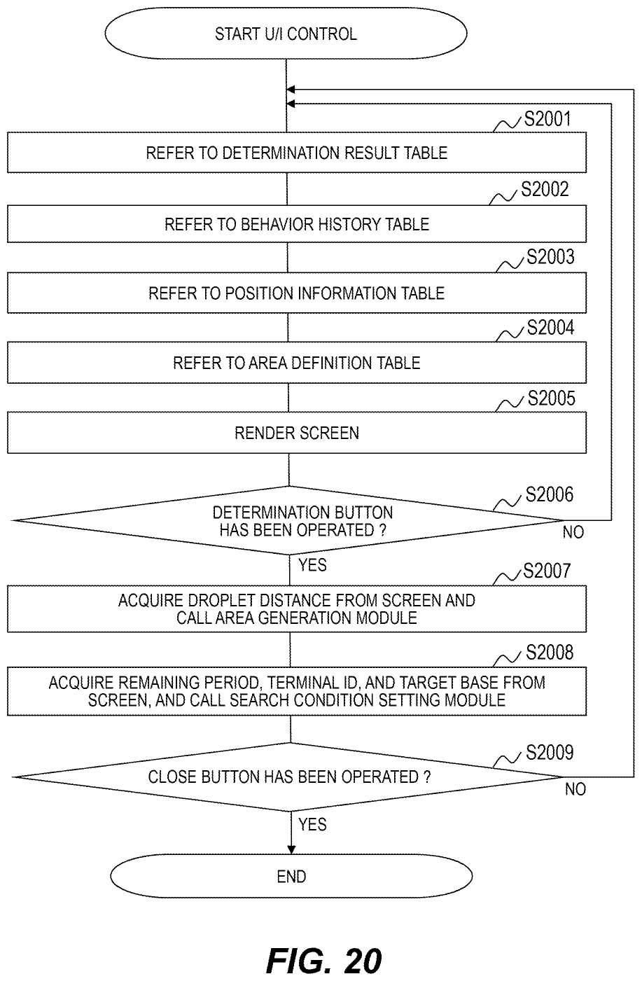

FIG. 20 is a flowchart for illustrating processing executed by the U/I control module 1602 of the analysis device 100 in the second embodiment.

The U/I control module 1602 refers to the determination result table 311, the behavior history table 310, the position information table 306, and the area definition table 303 (Step S2001 to Step S2004), and renders a contact determination screen (Step S2005). An example of the contact determination screen is described later with reference to FIG. 21. When the tables read out in Step S2001 to Step S2004 do not include a record, the U/I control module 1602 may display a blank.

After that, the U/I control module 1602 determines whether or not a determination button (described later) has been operated (Step S2006). When the determination button has been operated, the U/I control module 1602 acquires the droplet distance from the contact determination screen, and calls the area generation module 1601 (Step S2007). The area generation module 1601 uses the acquired droplet distance to execute processing of FIG. 18.

After that, the U/I control module 1602 acquires the remaining period, the terminal ID, and the target base from the contact determination screen, and calls the search condition setting module 1603. The search condition setting module 1603 uses the acquired remaining period, terminal ID, and target base to execute processing of FIG. 19.

After that, the U/I control module 1602 determines whether or not a close button (described later) has been operated (Step S2009). When the close button has been operated, the processing is finished.

The U/I control module 1602 may, for example, periodically execute the above-mentioned processing, to thereby refresh the contact determination screen. As another example, the U/I control module 1602 may execute the above-mentioned processing in an event-driven manner, to thereby refresh the contact determination screen when a predetermined event occurs, for example, when a content of any one of the tables is updated.

FIG. 21 is an explanatory diagram for illustrating the contact determination screen displayed by the analysis device 100 in the second embodiment.

A contact determination screen 2100 of FIG. 21 is a screen displayed by the output device 205, and includes a droplet distance input portion 2101, a remaining period input portion 2102, a terminal ID input portion 2103, a target base input portion 2104, a determination button 2105, a close button 2106, a determination result display portion 2107, a behavior history display portion 2108, and an area display portion 2109.

The user inputs the droplet distance, the remaining period, the terminal ID, and the target base in the droplet distance input portion 2101, the remaining period input portion 2102, the terminal ID input portion 2103, and the target base input portion 2104, respectively. For example, the user inputs the terminal ID of the measurement device 150 held by a person 160 infected by a certain virus, a droplet distance up to which influence (for example, the infection) of this virus is likely to occur, a remaining period of influence (for example, infectivity) of this virus, and information on a base (target base) used by this person 160. The information on the target base may be acquired from, for example, attendance information on this person 160 managed by the business operation system 110 or the like. It should be noted that the information on the target base is used to reduce a load on the search processing for the information on this person 160 and the search can be executed without this information, and hence the information on the target base is not indispensable.

When the user inputs the above-mentioned information and uses the input device 204 (for example, a mouse) to operate the determination button 2105 (Step S2006), the area generation module 1601 receives the value input to the droplet distance input portion 2101, and executes processing (Step S2007 and Step S1801 to Step S1811). The search condition setting module 1603 receives the values input to the remaining period input portion 2102, the terminal ID input portion 2103, and the target base input portion 2104, and executes processing (Step S2008 and Step S1901 to Step S1904). The areas generated by the area generation module 1601 are displayed in the area display portion 2109.

After that, processing by the behavior extraction execution module 1604, the contact information generation module 103, and the determination likelihood calculation module 104 is executed. Results thereof are displayed in the determination result display portion 2107 and the behavior history display portion 2108. In the determination result display portion 2107, a content corresponding to the determination result table 311 is displayed. In the behavior history display portion 2108, a content corresponding to the behavior history table 310 is displayed. It should be noted that while only the behavior history based on the measurement result of the measurement device 150 corresponding to the terminal ID of “2” is illustrated in FIG. 7, behavior histories based on measurement results of the measurement devices 150 corresponding to the terminal IDs “2” and “1” are illustrated in a graph form having the time as a horizontal axis in the example of FIG. 21.

When the user uses the input device 204 to operate the close button 2106 (Step S2009), the contact determination screen 2100 closes, and the processing is finished.

According to the first embodiment and the second embodiment described above, the user owns the measurement device, categorizes each set of coordinates by the area in accordance with the droplet distance set in advance, and installs the transmission devices on a floor. The radio wave of the transmission device is received by the measurement device, and the time, the terminal ID, and the radio wave intensity of each device are transmitted to the analysis device. The analysis device identifies an area from the installation coordinates and the radio wave intensity of each transmission device, and records the area together with the time and the terminal ID. The analysis device receives the condition input of the specific terminal ID of a positive person or the like, the remaining period, and the target base. The analysis device extracts terminal IDs which have used the same area at the same time as the terminal ID or in the remaining period. The analysis device calculates the contact likelihood in combination with the business operation log such as the room entry/exit information. There are displayed the contact type which is set to the direct contact when the same area was used at the same time and is set to the indirect contact when the same area was used in the remaining period, the contact time calculated from the times, the terminal ID, the area, and the contact likelihood.

As a result, the transmission device installed on the floor covers the determination for the areas in the floor, and the determination can thus be made without an excessive cost for the device installation. Moreover, it is possible to determine the indirect contact in addition to the direct contact by extracting the terminal IDs which have used the same area at the same time and in the virus remaining period. Moreover, it is possible to quantitatively evaluate a risk of the contact by calculating the contact type, the contact time, and the contact likelihood based on the time used for the determination and the business operation log. As a result, it is possible to quantitatively evaluate the risk of the indirect contact between employees in addition to the direct contact between employees without excessive cost to install devices.

Moreover, the system in the embodiments of this invention may be configured as described below.

(1) There is provided an analysis device including a processor (for example, the processor 201), and a storage device (for example, the storage device 203). The storage device is configured to hold behavior history information (for example, the behavior history table 310) indicating a period in which each of a first terminal device (for example, the measurement device 150 having the terminal ID of “2”) and a second terminal device (for example, the measurement device 150 having the terminal ID of “1”) has stayed in a predetermined area of a space and a predetermined remaining period (for example, the remaining period 309-2 of the search condition table 309). The processor is configured to identify, as a period of a direct contact, a period in which the first terminal device and the second terminal device have simultaneously stayed in the area (for example, Step S1406), and to identify, as a period of an indirect contact, a period which is included in a period from an end point of the period in which the first terminal device has stayed in the area until the remaining period elapses, and in which the second terminal device has stayed in the area (for example, Step S1409).

As a result, the indirect contact can be determined in addition to the direct contact.

(2) In the above-mentioned item (1), the storage device is configured to hold radio wave information (for example, the information of the entries read out from the radio wave information table 356 and transmitted from the measurement information transmission module 353) indicating wireless signals received by the first terminal device and the second terminal device from a plurality of transmission devices installed in the space, arrangement information (for example, the arrangement definition table) indicating an arrangement of the plurality of transmission devices, and area definition information (for example, the area definition table 303) indicating an arrangement of the areas. The processor is configured to measure a position of the first terminal device and a position of the second terminal device at each time based on the radio wave information and the arrangement information (for example, Step S1204), and to identify the period in which each of the first terminal device and the second terminal device has stayed in the area based on the positions of the first terminal device and the second terminal device at each time and the area definition information (for example, Step S1304 to Step S1307).

As a result, the transmission devices installed on a floor cover the determination for the area in the floor, and the determination of the presence or absence of the contact can thus be made without an excessive cost for the device installation.

(3) In the above-mentioned item (2), the storage device is configured to hold business operation log information (for example, the room entry/exit information table 307) that relates to the first terminal device and the second terminal device, and is based on information other than the radio wave information. The processor is configured to compare a period in which each of the first terminal device and the second terminal device has not stayed in the area, which is identified based on the business operation log information, and the period in which each of the first terminal device and the second terminal device has stayed in the area, which is identified based on the behavior history information, with each other, and to calculate a likelihood of the direct contact and a likelihood of the indirect contact based on a result of the comparison (for example, Step S1502 and Step S1503).

As a result, the risk of the contact can quantitatively be evaluated by comparing the behavior history based on the positioning through use of the wireless signals with other information, to thereby calculate the likelihood of the determination result of the presence or absence of the contact.

(4) In the above-mentioned item (3), the processor is configured to calculate the likelihood so that the likelihood decreases as a ratio of an overlap portion between the period in which each of the first terminal device and the second terminal device has not stayed in the area, which is identified based on the business operation log information, and the period in which each of the first terminal device and the second terminal device has stayed in the area, which is identified based on the behavior history information, increases.

As a result, the likelihood of the determination result of the presence or absence of the contact can appropriately be calculated.

(5) In the above-mentioned item (3), the business operation log information includes information on an entry time (for example, the room entry time 307-2) at which each of the first terminal device and the second terminal device enters a region (for example, the base 130) including the area and an exit time (for example, the room exit time 307-3) at which each of the first terminal device and the second terminal device exits from the region including the area. The information is based on information read by a sensor (for example, the sensor 254) of the first terminal device and information read by a sensor (for example, the sensor 254) of the second terminal device.

As a result, the likelihood of the determination result of the presence or absence of the contact can appropriately be calculated.

(6) In the above-mentioned item (5), the business operation log information includes information on the entry time and the exit time identified based on information obtained by the sensor of the first terminal device and the sensor of the second terminal device reading a tag (for example, a QR code or a wireless tag) installed in correspondence to the region including the area.

As a result, the likelihood of the determination result of the presence or absence of the contact can appropriately be calculated.

(7) In the above-mentioned item (3), the analysis device further includes a display device (for example, the output device 205), and the display device is configured to display identification information on the first terminal device, identification information on the second terminal device, identification information on the area, the period of the direct contact, the period of the indirect contact, and the likelihood (for example, the contact determination screen 2100).

As a result, the result of the contact determination is presented to the user.

(8) In the above-mentioned item (2), the area definition information includes information indicating a size of the area (for example, the X lower limit 303-3, the X upper limit 303-4, the Y lower limit 303-5, and the Y upper limit 303-6), and the size of the area is defined based on a distance of dispersion (for example, the droplet distance) of pathogens discharged from a human body.

As a result, the area having an appropriate size can be defined for the contact determination.

(9) In the above-mentioned item (8), when the distance of the dispersion of the pathogens discharged from the human body is input, the processor is configured to update the area definition information based on the input distance (for example, Step S1801 to Step S1811).

As a result, the area having an appropriate size can be defined for the contact determination.

(10) In the above-mentioned item (1), the remaining period is a period in which target pathogens discharged from a human body maintain infectivity.

As a result, the presence or absence of the indirect contact can appropriately be determined.

This invention is not limited to the embodiments described above, and includes various modification examples. For example, the above-mentioned embodiments have been described in detail for better understanding of this invention, but this invention is not necessarily limited to an invention having all the configurations described above. A part of the configuration of a given embodiment may be replaced with a configuration of another embodiment, or the configuration of another embodiment can be added to the configuration of a given embodiment. It is also possible to add, delete, and replace other configurations for a part of the configuration of each embodiment.

A part or all of each of the above-mentioned configurations, functions, processing modules, processing means, and the like may be implemented by hardware by being designed as, for example, an integrated circuit. Each of the above-mentioned configurations, functions, and the like may be implemented by software by a processor interpreting and executing a program for implementing each function. Information such as the programs, tables, files, and the like for implementing each of the functions may be stored in a storage device such as a non-volatile semiconductor memory, a hard disk drive, or a solid state drive (SSD), or in a computer-readable non-transitory data storage medium such as an IC card, an SD card, or a DVD.

The control lines and information lines are illustrated to the extent considered to be required for description, and not all the control lines and information lines on the product are necessarily illustrated. In practice, it may be considered that almost all configurations are coupled to each other.

What is claimed is:

1. An analysis device, comprising:
a processor; and
a storage device,
wherein the storage device is configured to hold behavior history information indicating a period in which each of a first terminal device and a second terminal device has stayed in a predetermined area of a space and a predetermined remaining period, and
wherein the processor is configured to:
identify, as a period of a direct contact, a period in which the first terminal device and the second terminal device have simultaneously stayed in the predetermined area; and
identify, as a period of an indirect contact, a period which is included in a period from an end point of the period in which the first terminal device has stayed in the predetermined area until the predetermined remaining period elapses, and in which the second terminal device has stayed in the predetermined area.

2. The analysis device according to claim 1,
wherein the storage device is configured to hold radio wave information indicating wireless signals received by the first terminal device and the second terminal device from a plurality of transmission devices installed in the space, arrangement information indicating an arrangement of the plurality of transmission devices, and area definition information indicating an arrangement of the predetermined area, and
wherein the processor is configured to:
measure positions of the first terminal device and the second terminal device at each time based on the radio wave information and the arrangement information; and
identify the period in which each of the first terminal device and the second terminal device has stayed in the predetermined area based on the positions of the first terminal device and the second terminal device at each time and the area definition information.

3. The analysis device according to claim 2,
wherein the storage device is configured to hold business operation log information that relates to the first terminal device and the second terminal device, and is based on information other than the radio wave information, and
wherein the processor is configured to:
compare a period in which each of the first terminal device and the second terminal device has not stayed in the predetermined area, which is identified based on the business operation log information, and the period in which each of the first terminal device and the second terminal device has stayed in the predetermined area, which is identified based on the behavior history information, with each other; and
calculate a likelihood of the direct contact and a likelihood of the indirect contact based on a result of the comparison.

4. The analysis device according to claim 3, wherein the processor is configured to calculate the likelihood so that the likelihood decreases as a ratio of an overlap portion between the period in which each of the first terminal device and the second terminal device has not stayed in the predetermined area, which is identified based on the business operation log information, and the period in which each of the first terminal device and the second terminal device has stayed in the predetermined area, which is identified based on the behavior history information, increases.

5. The analysis device according to claim 3, wherein the business operation log information includes information on an entry time at which each of the first terminal device and the second terminal device enters a region including the predetermined area and an exit time at which each of the first terminal device and the second terminal device exits from the region including the predetermined area, the information being based on information read by a sensor of the first terminal device and information read by a sensor of the second terminal device.

6. The analysis device according to claim 5, wherein the business operation log information includes information on the entry time and the exit time identified based on information obtained by the sensor of the first terminal device and the sensor of the second terminal device reading a tag installed in correspondence to the region including the predetermined area.

7. The analysis device according to claim 3, further comprising a display device,
wherein the display device is configured to display identification information on the first terminal device, identification information on the second terminal device, identification information on the predetermined area, the period of the direct contact, the period of the indirect contact, and the likelihood.

8. The analysis device according to claim 2,
wherein the area definition information includes information indicating a size of the predetermined area, and
wherein the size of the predetermined area is defined based on a distance of dispersion of pathogens discharged from a human body.

9. The analysis device according to claim 8, wherein, when the distance of the dispersion of the pathogens discharged from the human body is input, the processor is configured to update the area definition information based on the input distance.

10. The analysis device according to claim 1, wherein the predetermined remaining period is a period in which pathogens discharged from a human body maintain infectivity.

11. An analysis method, which is executed by a computer system including a processor and a storage device,
the storage device being configured to hold behavior history information indicating a period in which each of a first terminal device and a second terminal device has stayed in a predetermined area of a space and a predetermined remaining period,
the analysis method comprising:
identifying, by the processor, as a period of a direct contact, a period in which the first terminal device and the second terminal device have simultaneously stayed in the predetermined area; and
identifying, by the processor, as a period of an indirect contact, a period which is included in a period from an end point of the period in which the first terminal device has stayed in the predetermined area until the predetermined remaining period elapses, and in which the second terminal device has stayed in the predetermined area.
